(19) United States
(12) Patent Application Publication
(10) Pub. No.: US 2012/0290964 A1
(43) Pub. Date: Nov. 15, 2012

(54) METHOD FOR CREATING BOOKMARK AND ELECTRONIC READING DEVICE USING THE SAME

(76) Inventors: Chia-Ying Lee, TAIPEI CITY (TW); Chi-Han Wang, TAIPEI CITY (TW)

(21) Appl. No.: 13/292,053

(22) Filed: Nov. 8, 2011

(30) Foreign Application Priority Data
Nov. 9, 2010 (TW) 099138474

(51) Int. Cl. G06F 3/048

(52) U.S. Cl. 715/776

(57) ABSTRACT

A method for creating a bookmark is used in an electronic reading device having a display module. The method for creating a bookmark includes the following steps. A first page image is displayed at the display module, and a corner of the first page image has a first pattern with a raised corner. A selection command is received. The first pattern is changed to a second pattern with a turned down corner. This invention can easily catch a user's eyes, further allowing the user to execute the bookmark function of the electronic reading device.

### CROSS-REFERENCE TO RELATED APPLICATIONS

This Non-provisional application claims priority under 35 U.S.C. §119(a) on Patent Application No(s). 099138474 filed in Taiwan, Republic of China on Nov. 9, 2010, the entire contents of which are hereby incorporated by reference.

### BACKGROUND OF THE INVENTION

1. Field of the Invention

This invention relates to a method for creating a bookmark and, more particularly, to a method for creating a bookmark in an electronic reading device.

2. Description of the Related Art

Even if books are digitized benefiting from science and technology progress, thus allowing the readers to carry light and thin electronic reading devices to enjoy reading anywhere and anytime. However, the habit of turning down the corner is still generally used in the electronic reading device and the system thereof. Conventional methods for creating a bookmark in an electronic reading device are usually achieved by touching specific buttons. The formed bookmark is essentially in the form of storing data or increasing extra marks at the page.

FIG. 1 is a schematic diagram showing a page image displayed by a conventional electronic reading device. FIG. 2 is a schematic diagram showing a page image with a bookmark displayed by the electronic reading device in FIG. 1. Please refer to FIG. 1 and FIG. 2 together. Although in the prior art a turned-down-corner bookmark 11 is created in the upper right corner of a page of an electronic reading device 1, no reminder is provided at the displayed page image if the bookmarking function is not started (in FIG. 1), thus failing to allow the user to know how and where to create the turned-down-corner bookmark 11. Accordingly, operating the conventional method has to be taken special care, and further this function has to be studied thus to allow the turned-down-corner bookmark 11 to be created at an appropriate place.

The aforementioned method is suitable for experiencers. Beginners may feel difficult indeed or they have to remember the operation method with special care. Further, since the text layout in Chinese is great different from that in English, and electronic reading devices from different producers are different from each other, users may have to adapt themselves to different methods for creating a turn-downed-corner bookmark when exchanging the electronic reading devices with each other.

### BRIEF SUMMARY OF THE INVENTION

One objective of the invention is to provide a method for creating a bookmark in an electronic reading device for users at different levels, thus allowing the users to easily create a turned-down-corner bookmark in reading. More particularly, the user can follow marking habits in reading physical books without remembering or studying how to operate by the method according to the invention, thus facilitating popularization of the electronic reading device.

One embodiment of a method for creating a bookmark is used in an electronic reading device. The electronic reading device has a display module. The method for creating a bookmark includes the following steps. A first page image is displayed at the display module, and a corner of the first page image has a first pattern with a raised corner. A selection command is received. The first pattern is changed to a second pattern with a turned down corner.

In one embodiment, the second pattern may be superposed on the first pattern.

In one embodiment, the corner may be the upper right corner of the first page image.

In one embodiment, the selection command may be generated by touching the corner and sliding toward the inside of the first page image by the user.

In one embodiment, the method for creating a bookmark may further include steps of receiving a removing command and changing the second pattern to the first pattern with a raised corner.

In one embodiment, the second pattern may include a figure, page information, or a color different from the first page image.

In one embodiment, the electronic reading device may further have a storage unit, and the method for creating a bookmark may further include the following steps. An inputting command may be received thus to call a bookmark option in the storage unit, and the bookmark option may include at least one first bookmark. Another one selection command may be received thus to display the first page image corresponding to the first bookmark.

In one embodiment, after the step of changing the first pattern to the second pattern, the method for creating a bookmark may further include the following steps. An inputting command may be received for a period of time. A second page image may be displayed, and a corner of the second page image may have the second pattern or a third pattern with a turned down corner.

An electronic reading device according to the embodiment of the invention includes a display module and an inputting module. The display module displays a first page image, and a corner of the first page image has a first pattern with a raised corner. When the inputting module receives a selection command, the first pattern is changed to a second pattern with a turned down corner.

In one embodiment, the second pattern may be superposed on the first pattern.

In one embodiment, the corner may be the upper right corner of the first page image.

In one embodiment, the selection command may be generated by touching the corner and sliding toward the inside of the first page image by the user.

In one embodiment, when the inputting module receives a removing command, the second pattern may be changed to the first pattern with a raised corner.

In one embodiment, the second pattern may include a figure, page information, or a color different from the first page image.

In one embodiment, when the inputting module receives a removing command, the second pattern may be changed to the first pattern with a raised corner.

In one embodiment, the electronic reading device may further include a storage unit. When the inputting module receives an inputting command, a bookmark option in the storage unit may be called. The bookmark option may include at least one first bookmark. When the inputting module receives another selection command, the first page image corresponding to the first bookmark may be displayed.

In one embodiment, after the first pattern is changed to the second pattern, the inputting module may receive an inputting command for a period of time, and the display module may display a second page image one corner of which has the second pattern or a third pattern with a turned down corner.

To sum up, the embodiment of the method for creating a bookmark in an electronic reading device according to the invention can easily catch the user's eyes by the pattern with a raised corner at the corner of the page image, further allowing the user to execute the turned-down-corner bookmark function of the electronic reading device. Further, the invention can be operated by a specific touch action or a specific gesture thus to be discriminated from the mis-touch or other control instructions, allowing the user to follow the habit of turning down the corner in reading the physical book. Compared with the prior art, the method for creating a bookmark in an electronic reading device according to the invention allows beginners to create a turned-down-corner bookmark at the electronic reading device, and it also allow the users to follow marking habits in reading physical books without any study, thus facilitating popularization of the electronic reading device.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing a page image displayed by a conventional electronic reading device;

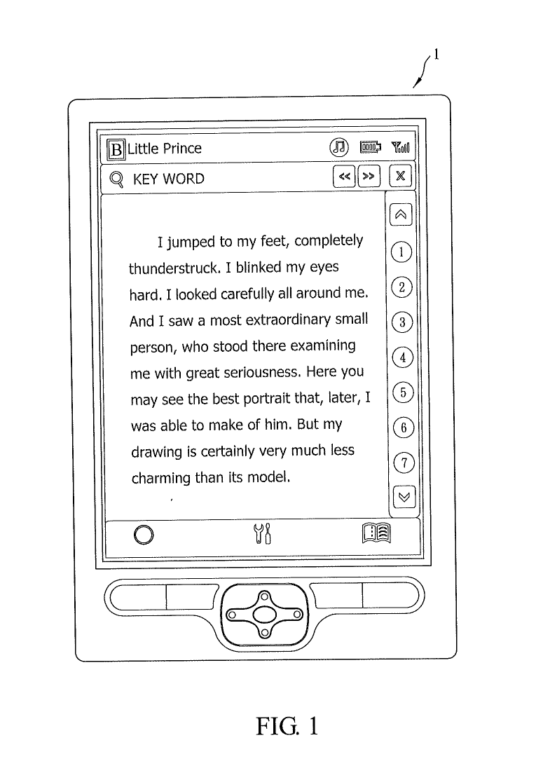

FIG. 2 is a schematic diagram showing a page image with a bookmark displayed by the electronic reading device in FIG. 1;

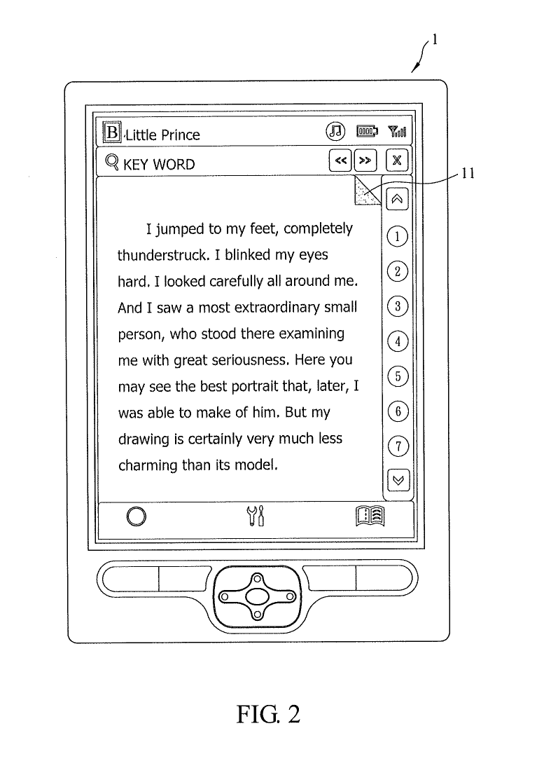

FIG. 3 is a flow chart showing a method for creating a bookmark according to one embodiment of the invention;

FIG. 4 is a schematic diagram showing a first page image displayed by an electronic book using the method according to the embodiment of the invention;

FIG. 5 is a schematic diagram showing that the electronic book in FIG. 4 is receiving a selection command;

FIG. 6 is a schematic diagram showing a second pattern changed from a first pattern displayed by the electronic book in FIG. 4; and

FIG. 7 is a schematic diagram showing that the electronic book in FIG. 6 is receiving a removing command.

### DETAILED DESCRIPTION OF THE INVENTION

One embodiment of the method for creating a bookmark and an electronic reading device using the same according to preferred embodiments of the invention may be described with related drawings. The same element may be described with the same reference number hereinbelow.

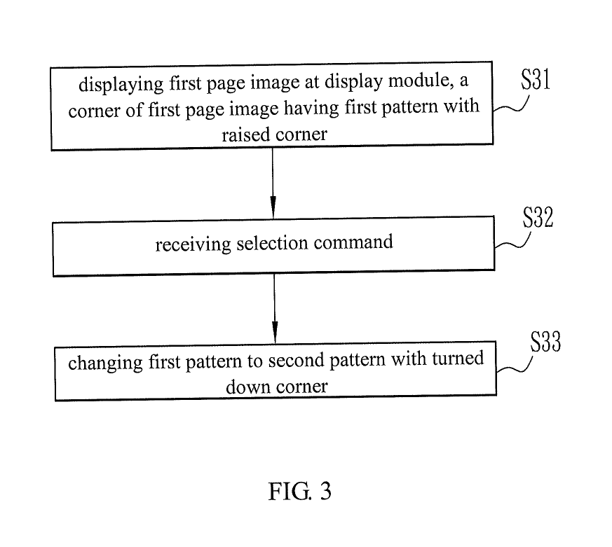

FIG. 3 is a flow chart showing a method for creating a bookmark according to one embodiment of the invention. Please refer to FIG. 3. The method is used in an electronic reading device having a display module. The method for creating a bookmark includes the following steps. A first page image is displayed at the display module, and a corner of the first page image has a first pattern with a raised corner (S31). A selection command is received (S32). The first pattern is changed to a second pattern with a turned down corner (S33).

To describe technical features of the invention in detail, an electronic book may be used as the electronic reading device hereinbelow. However, the invention is not limited thereto, and the electronic reading device may also be electronic paper, a smart phone, a personal digital assistant, a notebook, or a tablet computer.

The electronic book has a display module, an inputting module, a processing module, and a storage unit. The display module, the inputting module, and the storage unit are electrically connected with the processing module, respectively, thus allowing signals and data to be transmitted therebetween. Further, in the embodiments hereinbelow, the display module and the inputting module are combined into a touch screen. Of course, in other embodiments, the display module may also be a common display screen, and the inputting module may be a physical keyboard or a pointing unit such as a touch panel, a mouse, a voice-controlled unit, or others with similar functions. The invention is not limited thereto. Further, the processing module may be a micro-processor. The storage unit may be a built-in flash memory, a read-only memory, or a random-access memory, or it may be an external computer readable storage media such as a memory card, a compact disk, a flash disk, or a hard disk connected externally.

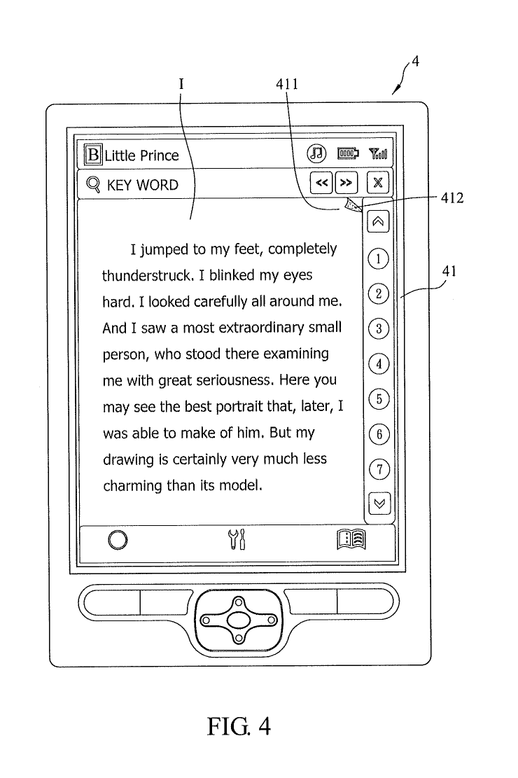

FIG. 4 is a schematic diagram showing a first page image displayed by an electronic book using the method according to the embodiment of the invention. Please refer to FIG. 3 and FIG. 4 together. In step S31, the electronic book 4 fetches data of the first page image stored in the storage unit by the processing module and displays the first page image I at the display module 41. A corner 411 of the first page image I has a first pattern 412 with a raised corner. The corner 411 of the first page image I may be the upper right corner, the upper left corner, the lower right corner, or the lower left corner of the first page image I, and the position is not limited in the invention. In this embodiment, the corner 411 of the first page image I is the upper right corner of the first page image.

Here the raised corner of the first pattern 412 may mean that the corner 411 is lifted or rolled up a little either inward or outward relative to the first page image I. In this embodiment, the raised corner means that the corner 411 is lifted a little inward relative to the first page image I. Since the first page image I is not a physical one, lifting or rolling up the corner 411 a little either inward or outward is just the visual effect for a user instead of the state change of the physical paper. Similarly, as long as the user can feel the difference between the first pattern 412 and the adjacent portion, the angle by which the corner 411 is lifted or rolled up a little either inward or outward is not limited to a standard one. Further, the raised corner is not limited to the aforementioned situation, and it may also be others presenting the same visual effects.

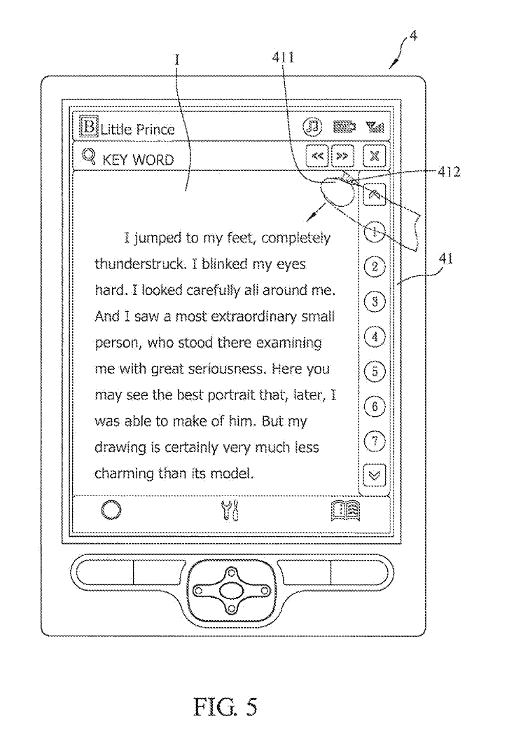

FIG. 5 is a schematic diagram showing that the electronic book in FIG. 4 is receiving a selection command. Please refer to FIG. 3 and FIG. 5 together. In the embodiment, in step S32, since the display module 41 and the inputting module are combined into a touch screen, when the user touches the corner 411 displayed by the display module 41, a selection command is provided for the electronic book 4. Then the electronic book 4 receives the selection command to create a bookmark. In the embodiment, the selection command received by the electronic book 4 is generated by touching the corner 411 and sliding toward the inside of the first page image I by the user. In detail, the user can touch the corner 411 of the first page image I by a fingertip or other suitable objects, and then he or she can slide toward the inside of the first page image I without departing from the surfaces of the electronic book 4. In the embodiment, sliding toward the inside of the first page image I is sliding toward the center of the first page image I. However, the sliding direction may also be toward the other side and/or the other corner of the first page image I, and the invention is not limited thereto.

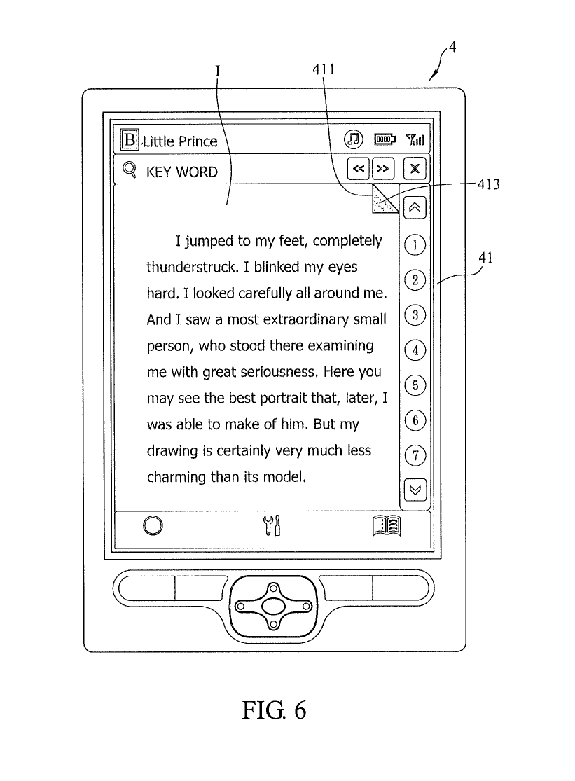

FIG. 6 is a schematic diagram showing a second pattern changed from a first pattern displayed by the electronic book in FIG. 4. Please refer to FIG. 3 and FIG. 6 together. In step S33, when the electronic book 4 receives a selection command, the processing module processes the selection command and thus outputs a signal to fetch data stored in the storage unit, and then the first pattern 412 originally displayed is changed to a second pattern 413 with a turned down corner. In other words, the first page image I having the second pattern 413 with a turned down corner is the page image with a bookmark. In detail, the first page image I is the basically same as that before change except that the corner 411 displays the second pattern 413. Accordingly, the user can create the bookmark by providing the selection command by touching the electronic book 4 as turning down a physical page corner. However, considering the view of the user, the image displayed by the electronic book 4 either with the first pattern 412 or with the second pattern 413 is always called as the first page image I, while the data of the page image in the two cases is materially different.

Please refer to FIG. 6. In the embodiment, the turned down portion of the second pattern 413 is a triangle. However, in another embodiment, the turned down portion may be a trapezium, an irregular shape, or the shape formed by a plurality of overlapping and folding. Further, in the embodiment, the second pattern 413 can also include and display a figure, page information, a color different from the first page image I, or a combination thereof (not shown) for providing related information for the user or enhancing the reminding function. For example, the second pattern 413 can display a figure indicating the numbering order of the bookmark.

In addition, in the embodiment, when the selection command is provided by touching the corner 411, the touching range can be changed to allow the electronic book 4 to generate different second patterns 413. For example, please refer to FIGS. 3 through 5. In the embodiment, in step S32, the second pattern 413 is superposed on the first pattern 412, while in other embodiments, when the user touches the corner 411 by a fingertip and then slides towards the inside of the first page image I by a long distance or in a great swinging range, a large or a eye-catching second pattern 413 may be generated to allow the second pattern 413 to overlap the first pattern 412 or to allow the second pattern 413 to have protruding portions besides superposing on the first pattern 412. On the other hand, if the sliding distance is short, the generated second pattern 413 may not be eye-catching. Accordingly, the user can create bookmarks at different importance levels.

The method for creating a bookmark in an electronic reading device according to the embodiments of the invention can easily catch the user's eyes by a special pattern at the corner of the page image, further allowing the user to execute the turned-down-corner bookmark function of the electronic reading device.

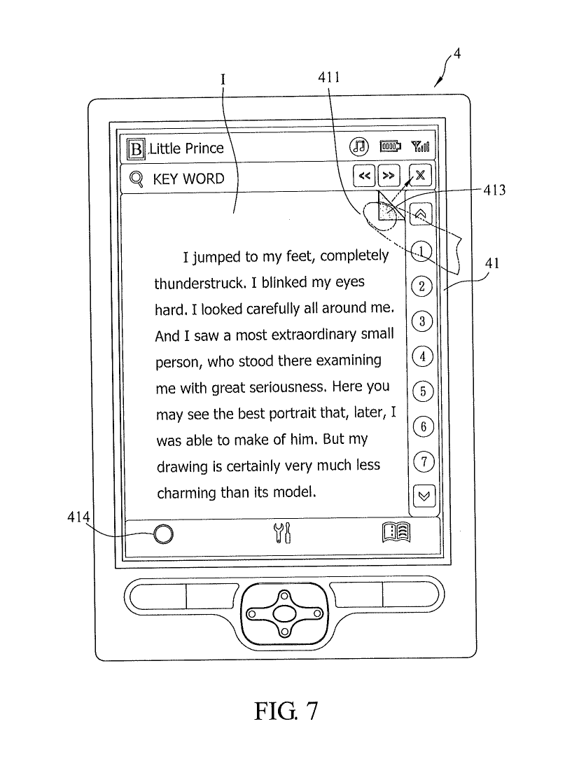

FIG. 7 is a schematic diagram showing that the electronic book in FIG. 6 is receiving a removing command. Please refer to FIG. 7. The method for creating a bookmark according to the embodiment may further include a step of receiving a removing command to allow the second pattern 413 to be changed to the first pattern 412 with a raised corner (in FIG. 4) after step S33. In this step, the user can touch the upper right corner 411 of the first page image I displayed at the display module 41 by a fingertip or other objects, thus providing the removing command for the electronic book 4 to remove the second pattern 413 thus to allow the electronic book 4 to re-display the first page image I one corner 411 of which has the first pattern 412. In detail, the user can touch the corner 411 of the first page image I and then slide toward the outside of the first page image I. This action is similar to that in FIG. 5, and the only difference is that the operating directions in the two cases are opposite. Accordingly, the user can cancel the bookmark originally created on the page, allowing the method for creating a bookmark in an electronic reading device to be more flexible.

Further, in the embodiment, the method for creating a bookmark in an electronic reading device may further include steps of receiving an inputting command for a period of time and displaying a second page image after step S33 of changing the first pattern to the second pattern. One corner of the second page image has a second pattern or a third pattern with a turned down corner. In this step, the user can touch the second pattern 413 at the display module 41 for a period of time by a fingertip or other objects, thus allowing the electronic book 4 to display the second page image one corner of which also has the second pattern 413. That is, another page with a bookmark is displayed. The period of time is not limited, and it can be built-in or be adjusted by the user. In the embodiment, the period of time may be built-in such as 2 seconds. However, as long as the pattern at the corner of the second page image has the same function of the pattern 413, they are not necessarily the same with each other. In other embodiments, one corner of the second page image may also have a third pattern with different shapes, sizes, or effects. In a word, the user can quickly browse next page image with a bookmark by the aforementioned action, thus enhancing the bookmark function of the electronic book.

Further, please refer to FIG. 7 again. In the embodiment, the method for creating a bookmark may further include steps of receiving an inputting command thus to call a bookmark option in the storage unit including at least one first bookmark and receiving another one selection command thus to display the first page image corresponding to the first bookmark after step S33. In detail, in this step, the user can touch a virtual bookmark-option button 414 to provide the inputting command. When the electronic book 4 receives the inputting command, it may call the bookmark option stored in the storage unit by transmitting signals by the processing module thus to display the bookmark option at the display module 41. In the embodiment, the bookmark option can list a plurality of bookmarks including the first bookmark. Further, each of the bookmarks can be linked to the page image one corner of which has a pattern with a turned down corner, i.e. the page image with a bookmark, respectively, by a program such as a hyperlink. Accordingly, the user can quickly select the desired page, thus enhancing the application flexibility and function of the invention to allow the user to follow habits in reading physical books.

Correspondingly, the embodiment of the invention further provides an electronic reading device. However, the electronic reading device is described above, and therefore it is not described for a concise purpose.

To sum up, the method for creating a bookmark in an electronic reading device according to the embodiments of the invention can easily catch the user's eyes by the pattern with a raised corner at the corner of the page image, further allowing the user to execute the turned-down-corner bookmark function of the electronic reading device. Further, the embodiments of the invention can be operated by a specific touch action or a specific gesture and it can even cancel the originally created bookmark thus to be discriminated from the mis-touch or other control instructions, allowing the user to follow the habit of turning down the corner in reading the physical book. Compared with the prior art, the method for creating a bookmark in an electronic reading device according to the embodiments of the invention allows beginners to create a turned-down-corner bookmark at the electronic reading device, and it also allows the users to follow marking habits in reading physical books without any study, thus facilitating popularization of the electronic reading device.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for creating a bookmark in an electronic reading device, the electronic reading device having a display module, the method for creating a bookmark comprising the following steps of:
displaying a first page image at the display module, a corner of the first page image having a first pattern with a raised corner;
receiving a selection command; and
changing the first pattern to a second pattern with a turned down corner.

2. The method for creating a bookmark according to claim 1, wherein the second pattern is superposed on the first pattern.

3. The method for creating a bookmark according to claim 1, wherein the selection command is generated by touching the corner and sliding toward the inside of the first page image by the user.

4. The method for creating a bookmark according to claim 1, further comprising steps of:
receiving a removing command; and
changing the second pattern to the first pattern with a raised corner.

5. The method for creating a bookmark according to claim 1, wherein the corner is the upper right corner of the first page image.

6. The method for creating a bookmark according to claim 1, wherein the second pattern comprises a figure, page information, a color different from the first page image, or a combination thereof.

7. The method for creating a bookmark according to claim 1, wherein the electronic reading device further has a storage unit, and the method for creating a bookmark further comprises steps of:
receiving an inputting command thus to call a bookmark option in the storage unit, the bookmark option including at least one first bookmark; and
receiving another one selection command thus to display the first page image corresponding to the first bookmark.

8. The method for creating a bookmark according to claim 1, after the step of changing the first pattern to the second pattern with a turned down corner, the method for creating a bookmark further comprising steps of:
receiving an inputting command for a period of time; and
displaying a second page image, a corner of the second page image having the second pattern or a third pattern with a turned down corner.

9. An electronic reading device comprising:
a display module for displaying a first page image, a corner of the first page image having a first pattern with a raised corner; and
an inputting module,
wherein when the inputting module receives a selection command, the first pattern is changed to a second pattern with a turned down corner.

10. The electronic reading device according to claim 9, wherein the second pattern is superposed on the first pattern.

11. The electronic reading device according to claim 9, wherein the selection command is generated by touching the corner and sliding toward the inside of the first page image by the user.

12. The electronic reading device according to claim 9, wherein when the inputting module receives a removing command, the second pattern is changed to the first pattern with a raised corner.

13. The electronic reading device according to claim 9, wherein the corner is the upper right corner of the first page image.

14. The electronic reading device according to claim 9, wherein the second pattern comprises a figure, page information, a color different from the first page image, or a combination thereof.

15. The electronic reading device according to claim 9, further comprising a storage unit, wherein when the inputting module receives an inputting command, a bookmark option in the storage unit is called, the bookmark option includes at least one first bookmark, and when the inputting module receives another selection command, the first page image corresponding to the first bookmark is displayed.

16. The electronic reading device according to claim 9, after the first pattern is changed to the second pattern with a turned down corner, the inputting module receiving an inputting command for a period of time, and the display module displaying a second page image one corner of which has the second pattern or a third pattern with a turned down corner.
